(19) United States
(12) Patent Application Publication
(10) Pub. No.: US 2009/0301821 A1
(43) Pub. Date: Dec. 10, 2009

(54) ELEVATOR ENTRANCE APPARATUS

(75) Inventors: Takeshi Fujiki, Tokyo (JP); Kensuke Imajo, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: MITSUBISHI ELECTRIC CORPORATION, Chiyoda-ku (JP)

(21) Appl. No.: 12/540,720

(22) Filed: Aug. 13, 2009

Related U.S. Application Data
(63) Continuation of application No. PCT/JP2007/055370, filed on Mar. 16, 2007.

(51) Int. Cl. B66B 13/28; B66B 13/24

(52) U.S. Cl. 187/400

(57) ABSTRACT

A doorway device for an elevator has a safety shoe provided at a closing side end of a car door, and the car door is provided with a shoe interlock mechanism. The shoe interlock mechanism has a link member for shoe movement moved relative to the car and to the car door when the car door is moved in association with the movement of the car door relative to a car. The movement of the safety shoe relative to the car door is associated with the movement relative to the car door of the link member for shoe movement. A closing member is provided under a car sill. The closing member is movable between a closing position where a sill gap between the car sill and a landing sill is closed and an opening position where the sill gap is opened. A closing member interlock mechanism is connected between the shoe interlock mechanism and the closing member. The closing member interlock mechanism moves the closing member in association with the movement relative to the car of the link member for shoe movement.

### TECHNICAL FIELD

The present invention relates to an elevator entrance apparatus to close a sill gap between the car sill and the landing sill.

### BACKGROUND ART

Conventionally, to prevent keys etc. from dropping down an elevator shaft from the sill gap between a car sill and a landing sill, there has been proposed an elevator entrance apparatus. When the passenger gets on and off the car, the elevator entrance apparatus closes the sill gap by a closing member. A car's door driving motor and a closing member are connected by a wire. The closing member is revolved by the movement of the wire by a force of the car's door driving motor. The sill gap between the car sill and the landing sill is closed by the turning of the closing member (see Patent Document 1)

Patent Document 1: JP2000-229773 A

### DISCLOSURE OF THE INVENTION

### Problem to be Solved by the Invention

However, with such a conventional elevator entrance apparatus, in order to transmit the force of the door driving motor to the closing member, the wire and a pulley are needed. And, because a revolution stroke of the door driving motor is longer than the wire's movement, a large reduction gear is needed to coordinate the wire's movement. In the end, there is a high equipment introduction cost and the equipment is complicated.

The present invention's purpose is to solve the above problem. It is an object to provide an elevator entrance apparatus, which make it possible to close the sill gap with a simple construction and a low price.

### Means for Solving the Problems

An elevator entrance apparatus, comprising:

an elevator door which is provided with a car and is movable to an open and close position;

a safety shoe which is provided on a closing-side end of the elevator door and projects from the elevator door and retracts into the elevator door;

a shoe interlocking member that comprises:

link members which synchronize with the movement of the elevator door against the car, and move against the car and the elevator door, and the movement of the link members against the elevator door synchronizes with the movement of the safety shoe against the elevator door;

a closing member which is able to close a sill gap between a car sill and a landing sill;

an interlocking member for closing member is provided between the shoe interlocking member and the closing member, and work together a movement of the shoe interlocking member and moves the closing member to close the sill gap to close the sill gap.

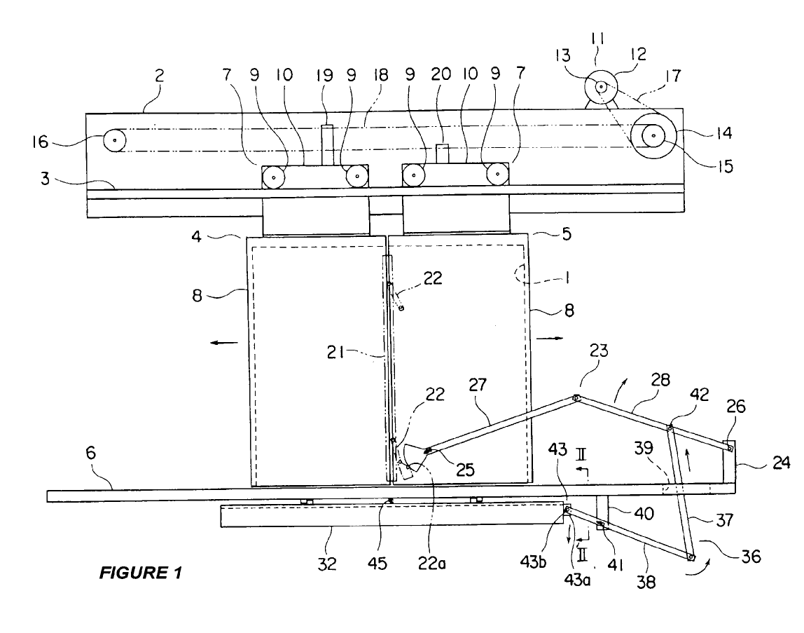

FIG. 1 is a front view showing, when the doors are closed, a door device for an elevator according to Embodiment 1;

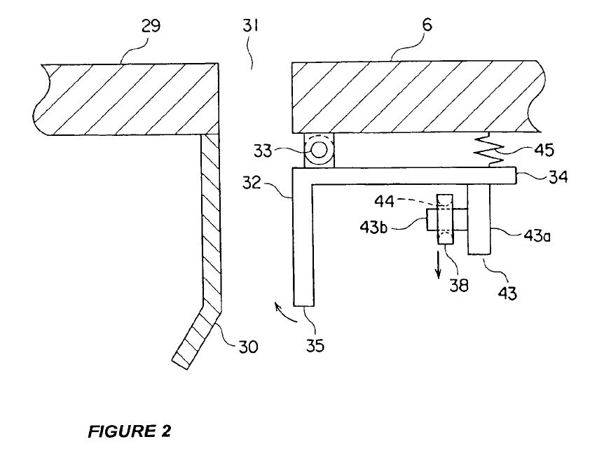

FIG. 2 is a sectional view taken along the line II-II of FIG. 1;

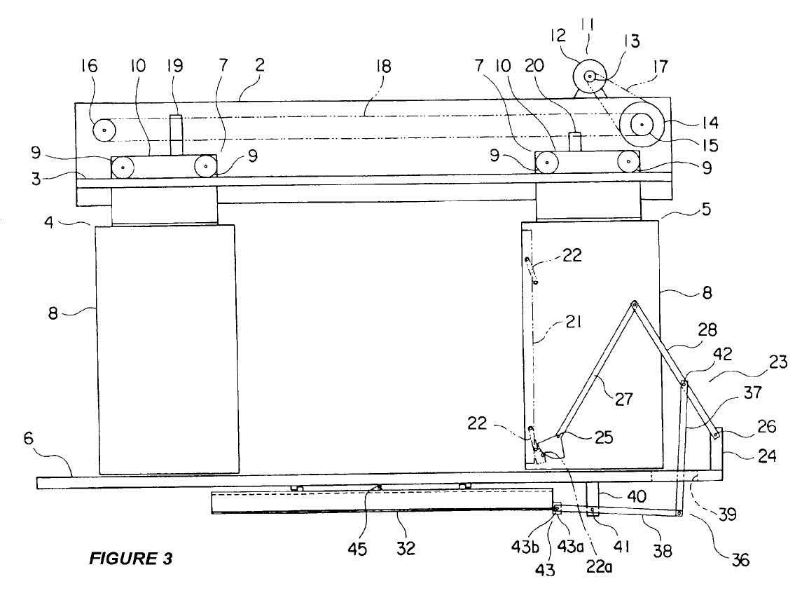

FIG. 3 is a front view showing the door device of FIG. 1, when the doors are open;

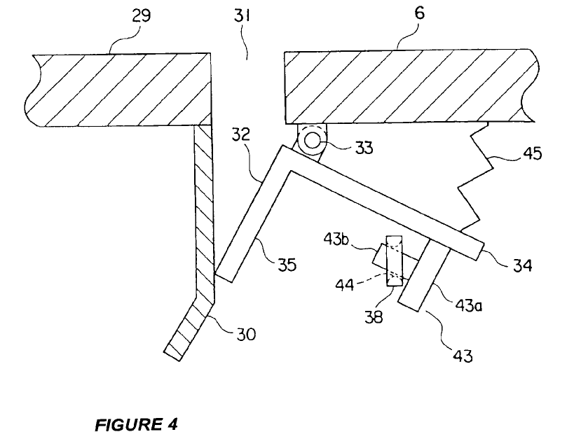

FIG. 4 is a sectional view showing a state in which a closing member closes a still gap of FIG. 2.

In the following, preferred embodiments of the present invention will be described with reference to the drawings.

### Embodiment 1

FIG. 1 is a front view showing a door device for an elevator, when the doors are in a closed state. FIG. 2 is a sectional view taken along the line II-II of FIG. 1. A car doorway 1 is provided with a car (not shown). A hanger case 2, which hangs the car doorway 1, is fixed to the car.

A door rail 3, which is extending in a direction of the car doorway 1, is provided on the hanger case 2. Elevator doors 4, 5 for opening and closing the car doorway 1 are suspended from the door rail 3.

The elevator doors 4, 5 are movable in the direction of the car doorway 1. The car doorway 1 is opened and closed by the movement of the doors 4, 5 in the direction of the car doorway 1. FIG. 3 is a front view showing the doors open state of the door device of FIG. 1. FIG. 1 and FIG. 3 show that the elevator doors 4, 5 are movable between the position where the car doorway 1 is closed (FIG. 1) and the position where the car doorway 1 is open (FIG. 3).

A car sill 6, which is arranged along the direction of the car doorway 1, is fixed to the lower portion of the car doorway 1. Guide grooves (not shown), which are arranged along the movable direction of the elevator doors 4, 5, are provided with the car sill 6. The lower portion of the car doors 4, 5 are inserted into the guide grooves.

The car doors 4, 5 have a door hanger 7 and a door panel 8. The door hanger 7 can move along the hanger rail 3. The door panel 8 is provided at the under portion of the door hanger 7. The door panel 8 moves with the door hanger 7, and the door panel 8 opens and closes the car doorway 1.

Each of the door hangers 7 has a plurality of hanger rollers 9 and a door hanger body (a door hanger plate) 10. The hanger rollers 9 are provided along the door rail 3 at intervals. The plurality of hanger rollers 9 are provided to the door hanger body 10.

Each of the hanger rollers 9 are on the hanger rail 3. When the door hanger 7 moves along the door rail 3, each of the hanger rollers 9 rolls on the hanger rail 3.

A door driving device 11 is provided on the hanger case 2. The door driving device 11 has a motor 12 and a driving pulley 13. The driving pulley 13 is mounted on the motor's rotary shaft. A transmission pulley 14 and a first moving door pulley 15 are provided at the end of the hanger case 2. A second moving door pulley 16 is provided at the other end of the hanger case 2.

A transmission belt 17, which is an endless belt, is wound around the driving pulley 13 and the transmission pulley 14. The rotation force from the driving pulley 13 is transmitted to the transmission pulley 14 through the orbital movement of the transmission belt 17. The transmission pulley 14 and the first moving door pulley 15 are united, and rotate together.

The first moving door pulley 15 and the second moving door pulley 16 are wound around a door moving belt (transmission strip body) 18, which is an endless belt. The door moving belt 18 runs by the rotation of the first moving door pulley 15. Due to the rotation of the door moving belt 18, the second moving door pulley 16 rotates.

In order to move each elevator door 4, 5 in the opposite direction using the orbital movement of the door moving belt 18, the elevator doors 4, 5 are connected to the belt 18 through the coupling members 19, 20.

A safety shoe 21 is provided on a closing-side end of the elevator door 5 through a pair of shoe installation members 22. Each shoe installation member 22 can rotate relative to the elevator door 5. The lower side shoe installation member 22 has a touching member 22a. Due to the turning of each shoe installation member 22, the safety shoe 21 projects from the elevator door 5 and retracts into the elevator door 5. The safety shoe 21 is a device which can be used to stop a door from closing and pinching a person or an object. The safety shoe 21 may be linked to, connected with, or otherwise interfaced with an electrical, electrical-mechanical, and/or electro-optical switching element to detect or indicate that the safety shoe is being pushed in or that the doorway is blocked.

A shoe interlocking member 23 is provided with the car. Alternatively, the shoe interlocking member and the associated hardware to may be provided on each floor, and not unique to the car. The shoe interlocking member 23 synchronizes the movement of the elevator door 5 (that is, the movement of the elevator door 5 to open and close) with the car, and the movement of safety shoe 21 relative to the elevator door 5. The shoe interlocking member 23 is connected between a fixed member 24 fixed on the car sill 6 (that is, fixed on the car) and elevator door 5.

A door side joint 25 is provided at the elevator door 5, and is a pivot point. A fixed member side joint 26 is fixed to the fixed member 24, and is also a pivot point. The shoe interlocking member 23 has a door side link member (first link member for shoe movement) 27 and a fixed member side link member (second link member for shoe movement) 28. The door side link member 27 can turn about the door side joint 25. The fixed member side link member 28 can turn about the fixed member side joint 26.

The door side link member 27 is connected with the fixed member side link member 28, and the door side link member 27 can turn the fixed member side link member 28. According to one embodiment, the joint at which the door side link member 27 is connected to the fixed member side link member 28 is a joint which can move, depending on the position and/or movement of the members 27 and 28. According to the closing and opening of the elevator door 5, the door side link member 27 turns about the door side joint 25, and the fixed member side link member 28 turns about the fixed member side joint 26. That is, the door side link member 27 and the fixed member side link member 28 synchronize with the movement of the elevator door 5 against the car, and move against the car and the elevator door 5.

The touching member 22a abuts the edge of the door side link member 27. In one embodiment, the touching member 22a is fixed to the door side link member 27, and the position of the touching member 22a remains fixed relative to the door side link member 27, and touching member 22a and door side link member 27 pivot or rotate as a unit about the door side joint 25 as the door 5 opens and closes. According to the movement (turning) of the door side link member 27 against the elevator door 5, the shoe installation member 22 turns against the elevator door 5 as abutting against the door side link member 27. According to the turning of the shoe installation member 22 against elevator door 5, safety shoe 21 moves against elevator door 5. That is, the safety shoe 21 synchronizes with the movement of the door side link member 27 against elevator door 5, so the safety shoe 21 moves between the projection position (FIG. 1) and the retreat position (FIG. 3). As a result, the safety shoe 21 moves to the projection position by the movement of elevator door 5 to the closed position, and safety shoe 21 is moved to the retreat position by the movement of the elevator door 5 to the opened position. According to an embodiment of the invention, the safety shoe 21 is retracted when the elevator doors are fully closed or fully open, and projects from the door 5 into the doorway at door positions other than being fully open or fully closed. Alternative movements and positions of the safety shoe 21 are also possible. For example, the safety shoe may remain projecting, even if the doors are fully open, if desired. The movement and position of the safety shoe is controlled by the shape of the touching member 22a. This touching member 22a can be considered to have a cam surface at the region where it contacts the shoe installation member 22, and depending on the profile of the cam surface, can extend or retract the safety shoe 21, as desired. For example, if the distances from the joint 25 of an outer surface of the touching member 22a is longer at end portions than at a center portion, the safety shoe 21 will be retracted at the fully opened and fully closed positions, and extend outwardly from the door 5 when the door 5 is at a position other than being fully closed or fully open.

While not shown in the figures for simplicity, the safety shoe 21 and the shoe interlocking member 23 are installed in not only elevator door 5 but also in elevator door 4.

There is a hall gateway, which is opened and closed by coupling of the hall doors (not shown) on each floor. When the car stops on each floor, each hall door is opposite to the corresponding elevator door 4, 5. With a connection device (not shown), each of the hall doors moves with each elevator door 4, 5. Each of the floor's hall gateway is opened and closed by the movement of each the hall door.

FIG. 2 shows a landing sill 29, which is arranged along the direction of the width of the hall gateway, on the hall gateway floor. There is a toe guard 30 under the landing sill 29 as a protection board. When the car stops on each floor, the car sill 6 and the landing sill 29 oppose each other through a sill gap 31.

A closing member 32 is provided under the car sill 6 to close the sill gap 31 between the car sill 6 and the landing sill 29. The closing member 32 is arranged along the car sill 6. And, the closing member 32 is provided under the car sill 6 through a rotation axis 33, which is arranged in the direction of the width of the car sill 6. Therefore, the closing member 32 can turns to the car sill 6 by turning round the rotation axis 33. Moreover, the closing member 32 has a long part 34 and a short part 35. The long part 34 is provided to the rotation axis 33. The short part 35 is arranged to extend downwardly from the landing sill 29 side of the long part 34.

FIG. 4 is a sectional view showing a state in which a closing member 32 closes a sill gap 31 of FIG. 2. In FIG. 2 and FIG. 4, by the turning of the closing member 32 on the car sill 6, the closing member 32 moves between the closed position (FIG. 4), which is the position the closing member 32 closes the sill gap 31, and the open position (FIG. 2), which is the position the closing member 32 opens the sill gap 31. According to the turning of the closing member 32 about the car sill 6, the end portion of the long part 34, which is opposite to the side of the landing sill 29, moves up and down against the car sill 6. By the turning of the closing member 32 to the car sill 6, the under portion of the short portion 35 touches the toe guard 30. When the closing member 32 is in the closed position, the short portion 35 touches the toe guard 30. By the touching of the short portion 35 with toe guard 30, the sill gap 31 is closed.

FIG. 1 and FIG. 3 show that the interlocking member for closing member 36 connects the shoe interlocking member 23 and the closing member 32. The interlocking member for closing member 36 works together the movement of the fixed member side link member 28 against the car sill 6 and the movement of the closing member 32 against the car sill 6. That is to say, according to the connection of the interlocking member for closing member 36 between the shoe interlocking member 23 and the closing member 32, the closing member 32 works together with the movement of the fixed member side link member 28, and the closing member 32 moves between the opening position and the closing position.

The interlocking member for closing member 36 has the shoe interlocking member side link member (the first link member for the closing member) 37 and the support side link member (the second link member for the closing member) 38. The shoe interlocking member side link member 37 and the support side link member 38 are connected to be able to turn each other.

The car sill 6 has a passing hole 39, and the shoe interlocking member side link member 37 passes through the car sill 6 through the passing hole 39. A support member 40 is fixed under the car sill 6 to support the support side link member 38. The middle part of the support side link member 38 is connected to the support member 40 through a support side joint 41.

The middle portion of the fixed member side link member 28 is connected to the shoe interlocking member side link member 37, which is through the passing hole 39, through a shoe member side joint 42. The support side link member 38, which is supported by the support member 40, is connected to the long part 34 of the closing member 32 through the closing member side joint 43.

According to the movement of the fixed member side link member 28 against the car sill 6, the shoe interlocking member side link member 37 moves up and dawn against to the car sill 6. According to the movement of the shoe interlocking member side link member 37, the support side link member 38 turns about the support side joint 41. That is, the shoe interlocking member side link member 37 and the support side link member 38 synchronize with the movement of the fixed member side link member 28 against the car sill 6, and the shoe interlocking member side link member 37 and the support side link member 38 move against the car sill 6.

FIG. 2 and FIG. 4 show that the closing member side joint 43 has a closing member fixation part 43a, which is fixed to the long part 34, and a projection part 43b, which projects from the closing member fixation part 43a. The projection part 43b is arranged vertically for the plane which is vertical to the long part 34 and contains the fixed shaft 33.

The support side link member 38 has a penetration hole 44 in which the projection part 43b is inserted. The minimum inside diameter of the penetration hole 44 is the middle portion of the penetration hole 44. The inside diameter of a penetration hole 44 is continuously growing toward the opening of the penetration hole 44. The support side link member 38 is connected with the closing member 32 through the projection of the projection part 43b to the penetration hole 44. As a result, the support side link member 38 can turn not only in the direction of the surroundings of the axis line of projection part 43b, but also in the direction of the axis line of projection part 43b against the closing member 32.

Because the support side link member 38 (FIG. 1 and FIG. 3) turns about the support side joint 41, the closing member side joint 43 moves up and down against the car sill 6. According to the movement of the closing member side joint 43, the closing member 32 moves between the closed position and the open position.

A power spring 45 (urging member) is connected between the closing member 32 and the car sill 6. The spring 45 urges the closing member 32 to the open position. That is, the spring 45 urges the closing member side joint 43 in the direction of the car sill 6.

According to the turning of the support side link member 38 about the support side joints 41, the closing member 32 moves from the open position to the closed position against the urging of the spring 45. That is, the interlocking member for closing member 36 moves the closing member 32 to the closed position against the urging of the power spring 45.

Next, an operation will be described. When each elevator door 4,5 is at the closed position, safety shoe 21 is arranged at the projection position and the closing member 32 is arranged at the open position. When the car stops at a floor, by the force of motion of the door drive device 11, the doors are opened. Each elevator door 4,5, which is connected to the corresponding hall doors, moves from the closed position (FIG. 1) toward the open position (FIG. 3). As a result, the door side link member 27 turns counter-clockwise about the door side joint 25, and the fixed member side link member 28 rotates clockwise about the fixed member side joint 26 (FIG. 1).

When the door side link member 27 turns counter-clockwise, the safety shoe 21 moves from the projection position to the retracted position. Moreover, when the fixed member side link member 28 turns clockwise, the shoe interlocking member side link member 37 moves upwardly.

According to the upward movement of the shoe interlocking member side link member 37, the support side link member 38 turns about the support side joint 41, and the closing member side joint 43 moves downward against the urging of power spring 45. When the closing member side joint 43 moves downward, the closing member 32 turns about the rotation axis 33 and the closing member 32 moves from the open position toward the closed position.

When each elevator door 4, 5 gets to the opening position, the safety shoe 21 reaches the retracted position and the closing member 32 reaches the closed position. As a result, the sill gap 31 between the car sill 6 and the landing sill 29 is closed by the closing member 32.

When elevator door 4, 5 closes due to the reversely turning of the door drive device 11, an opposite operation to the above-described operation is performed. As a result, the closing member 32 moves to the open position, and the blocked sill gap 31 becomes open.

In the doorway device for an elevator as described above, the interlocking member for the closing member 36 is connected between the closing member 32 and the shoe interlocking member 23, and the closing member 32 works together with the shoe interlocking member 23, so this device does not need additional large-scale equipment such as the reduction gears. Therefore, the sill gap 31 can be closed with a simple construction, and a reduction in the cost of manufacturing can also be achieved.

Moreover, the interlocking member for the closing member 36 has the support side link member 38. The closing member 32 synchronizes with the turning of the support side link member 38, and the closing member 32 moves between the closed position and the open position, so the closing member 32 moves against the car sill 6.

Moreover, because the closing member 32 turns about the rotation axis 33 arranged along the car sill 6, the composition becomes simple, and the closing member 32 moves against the car sill 6 easily.

Moreover, because the closing member 32 is urged to the open position by the spring 45, the closing member 32 moves to the open position. As a result, for instance, if the closing member 32 comes off the interlocking member of closing member 36, the closing member 32 is maintained in the open position. Therefore, when the car goes up and down, it prevents the closing member 32 from movement to the closed position, and destruction of the closing member 32 and the equipment in the way of the hoist does not occur. The shoe interlocking member 23 has been illustrated as extending to the right beyond the open position of the door 5. However, this is not a requirement of the invention, and the shoe interlocking member 23 can extend less than or equal to the rightmost position of the door 5, when the door 5 is in the open position.

1. An elevator entrance apparatus, comprising:
an elevator door which is provided with a car and is movable to an open and a close position;
a shoe interlocking member, one side of which is provided on the car and another side of which is provided on the elevator door, the shoe interlocking member moving as the elevator door moves relative to the car;
a closing member which closes a sill gap between a car sill and a landing sill; and
an interlocking member for the closing member provided between the shoe interlocking member and the closing member, the interlocking member moving due to a movement of the shoe interlocking member which moves the closing member to close the sill gap.

2. An elevator entrance apparatus according to claim 1, wherein the interlocking member for the closing member includes:
a support side link member, which works with the movement of the shoe interlocking member, and turns relative to the car.

3. An elevator entrance apparatus according to claim 1, wherein the closing member turns about a rotation axis to close the sill gap.

4. An elevator entrance apparatus according to claim 1, further comprising:
a spring between the car sill and the closing member.

5. An elevator door mechanism, comprising:
an elevator door:
a safety shoe which is attached to the elevator door;
a safety shoe positioner which moves the safety shoe from a retracted position to an extended position.
a device located below the elevator door;
an interlink connected to the device located below the elevator door and having a cam surface on one end which contacts the safety shoe positioner,
wherein an opening and closing of the elevator door causes a movement of the interlink which moves the cam surface which causes the safety shoe positioner and the safety shoe to move, and which causes a movement of the device located below the elevator door to close a gap at a front of the elevator door to prevent items from falling down a shaft.

6. An elevator door mechanism according to claim 5, wherein the device located below the elevator door is pivotally mounted such that movement of the interlink causes a rotation of the device located below the elevator door to close the gap at a front of the elevator door.

7. An elevator door mechanism according to claim 6, further comprising:
a spring which urges the device located below the door to a position which does not close the gap at the front of the elevator door.

8. An elevator door mechanism according to claim 5, wherein the interlink has a member pivotally mounted to the door, and the opening and closing of the door causes the member to pivot which rotates the cam surface of the interlink.

9. An elevator door mechanism according to claim 8, where in the interlink has another member pivotally mounted such that the pivoting of the member causes said another to pivot which moves a linkage which causes the device located below the elevator door to close the gap at a front of the elevator door.
